(19) United States
(12) Patent Application Publication
(10) Pub. No.: US 2004/0260783 A1
(43) Pub. Date: Dec. 23, 2004

(54) Method system and program product to exchange and process files on demand

(76) Inventor: Chris Fook-Choong Foo, Costa Mesa, CA (US)

Correspondence Address: Chris Foo, P.O. Box 28151, Santa Ana, CA, 92799, US

(21) Appl. No.: 10/458,673

(22) Filed: Jun. 11, 2003

(51) Int. Cl. G06F 15/173; G06F 15/16

(52) U.S. Cl. 709/217; 709/225

(57) ABSTRACT

This method and system is used to exchange and process files on demand. This system was developed to transmit and upon successful process transmitted files instantly, regardless of platforms. This system bridges the gap between programs transmitting data and programs processing the data. This method would leverage the connectivity of internet technologies allowing files and command to be transmitted remotely for processing.

### BACKGROUND

Companies often required transfer of data files within computers for processing, potentially in various locations. Processing data files upon successfully transmission often did not occur instantly or inefficient. To address these concerns, this system is built with integrated intranet technology, providing various protocols to deliver integrated solutions for transferring and processing data instantly into various applications.

### SUMMARY

The method system used in the program product will:

1. process data files instantly upon successful transfer the data files to target computer.

2. provide public and private keys encryption mechanism for transmitting data via Internet.

3. Eliminate the needs to have a separate centralized License Server to store encryption keys.

### DETAILED DESCRIPTION

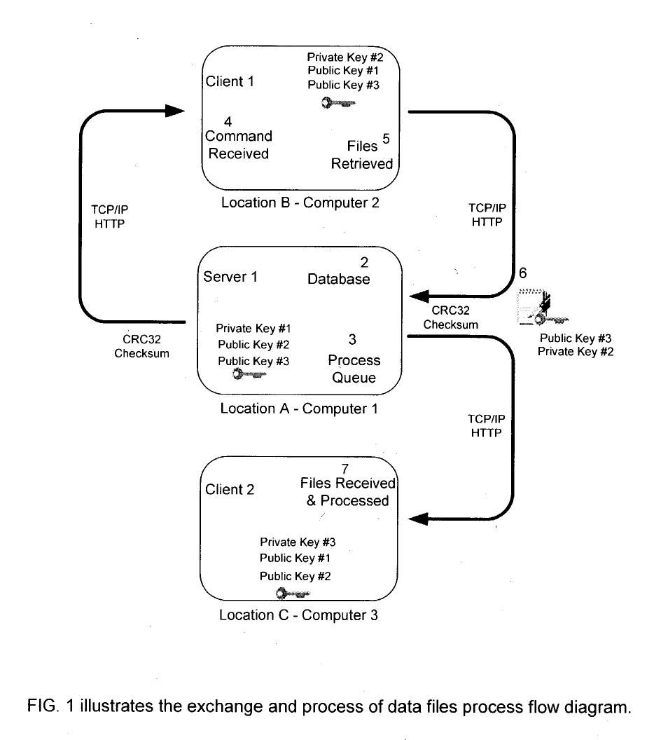

FIG. 1

1. Server program constantly queries the database and creates tasks identifier in the process queue (3) based on process priority.

2. The server program opens connections with client's computer where the program tasks will be executing.

3. The tasks identifier is encrypted; compressed as well as inserted a crc32 check sum value to ensure the integrity of the tasks identifier.

4. Client daemon program constantly listens for incoming connections from remote computers on a specific port (4) or Internet protocol address then decrypts and verifies the crc32 check sum value to ensure the command was received successfully.

5. Client daemon program obtains a single instance of current runtime class (5) and interfaces with the client's operating systems environment to execute the search and retrieve program.

6. Upon completion of the retrieving process, the client program encrypts with public and private keys, compresses, and inserts a crc32 check sum into the data steams,. and transmits the output (6) back to the server computer.

7. Server computer decrypts the input stream, validates crc32 check sum, updates the appropriate tables in the database and forward the data streams to destination computer for processing.

8. Destination Client daemon program decrypt the data streams with stored public and private keys and obtains a single instance of current runtime class (7) and interfaces with the client's operating systems environment to execute the processing program.

9. The server interface is a web based application where user can access remotely with a browser by clicking on a hyperlink to view the transmission or processing status.

What is claimed is:

1. A computer-implemented method for exchanging and processing files over a network on demand. The method comprising: receiving a task identifier associated with a remote source files; encrypting the task identifier; transmitting tasks identifier to remote client daemon; retrieving source files from remote client program; re-transmitting source files to destination client daemon for process execution.

2. The method of claim 1, wherein the task identifier comprises one of static and binary content.

3. The method of claim 1, wherein remote source files are any software data files resided on a different computer connecting via TCP/IP or HTTP protocol.

4. The method of claim 2, wherein binary content further comprises remote source filenames; remote source file paths; remote computer public key; and origin computer private key.

5. The method of claim 1, wherein encrypting step further comprises compressing the task identifier using standard compressing routines.

6. The method of claim 5, wherein compressing step further comprises inserting extra bits and repositions the compressed bits.

7. The method of claim 1, wherein remote client daemon is a program listens for incoming connections from remote computer on a specific port or Internet Protocol address and interacts with them.

8. The method of claim 1, wherein transmitting step further comprises making network connection to remote client daemon program.

9. The method of claim 7, wherein specific port comprises one static number ranging from 1024-9999 uniquely for every computer.

10. The method of claim 7, wherein Internet Protocol address comprises 32-bit numeric address written as four numbers separated by periods. Each number can be zero to 255.

11. The method of claim 1, wherein the steps of retrieve source files method further comprises the steps of: searching for source files; encrypting the data files; and transmitting data files.

12. The method of claim 11, wherein searching for source files further comprises find and move source files to a target directory.

13. The method of claim 11, wherein encrypting the data files further comprises standard encryption with source computer private key and destination computer public key.

14. The method of claim 1, wherein the steps of re-transmitting source files to destination client daemon for process execution further comprises the steps of: checking the integrity of the data files using crc32 check sum method; decrypting data files; and updating database.

15. The method of claim 14, wherein checking the integrity of the data files comprises of comparing the crc32 value.

16. The method of claim 14, wherein decrypting data files comprises of decryption routines utilizing destination private key and source computer public key.

17. The method of claim 14, wherein updating steps comprises resetting status of the job associated with task identifier.

18. The method of claim 17, wherein resetting status of job is to preventing the server from receiving identical task identifier and retry if transmission failed.

19. The method of claim 1, wherein process execution step further comprises obtaining a single instance of class Runtime that allows the client daemon programs to interface with the environment in which the client daemon is running.

20. A network system for transmitting information among a group of participants, comprising: a server for generating and sending a task identifier associated with a remote program. The server further comprising a web based interface responsive to retrieve the link identifier.

21. The network system of claim 20, wherein the link identifier is a Universal Resource Locator.

22. The network system of claim 20, wherein the network is further comprises of Local Area Networks (LANs); Wide-Area-Networks (WANs); and Metropolitan-Area-Networks (MANs).
